(19) United States
(12) Patent Application Publication
(10) Pub. No.: US 2023/0185927 A1
(43) Pub. Date: Jun. 15, 2023

(54) DEVICE FOR TRANSFORMING A DATASET WITH A SECRET KEY

(71) Applicant: TMIA GmbH, Linz (AT)

(72) Inventor: Jürgen Auracher, Deceased (AT)

(21) Appl. No.: 17/923,574

(22) PCT Filed: Apr. 27, 2021
(86) PCT No.: PCT/AT2021/060146

§ 371 Date: Nov. 5, 2022

(30) Foreign Application Priority Data
May 6, 2020 (AT) A60141/2020

(51) Int. Cl. G06F 21/60; G06F 21/62

(52) U.S. Cl. CPC G06F 21/602; G06F 21/6227

(57) ABSTRACT

A device for transforming a dataset with a secret key, wherein a query unit (1) is connected via a bidirectional communication interface (2) to a transformation unit (3), has a memory (4) for the secret key and a processor (5) for transforming the dataset. For reliable and secure execution of digital transactions, the query unit (1) has optical transmitters transmitting in parallel codewords of the dataset translated into two-dimensional codewords to optical receivers of the transformation unit (3), and the transformation unit (3) has optical transmitters transmitting in parallel codewords of the transformed dataset translated into two-dimensional codewords to a plurality of optical receivers of the query unit (1). The transmitters and receivers of a unit are arranged each in a two-dimensional grid and opposite and at a distance from the receivers and transmitters of the other unit.

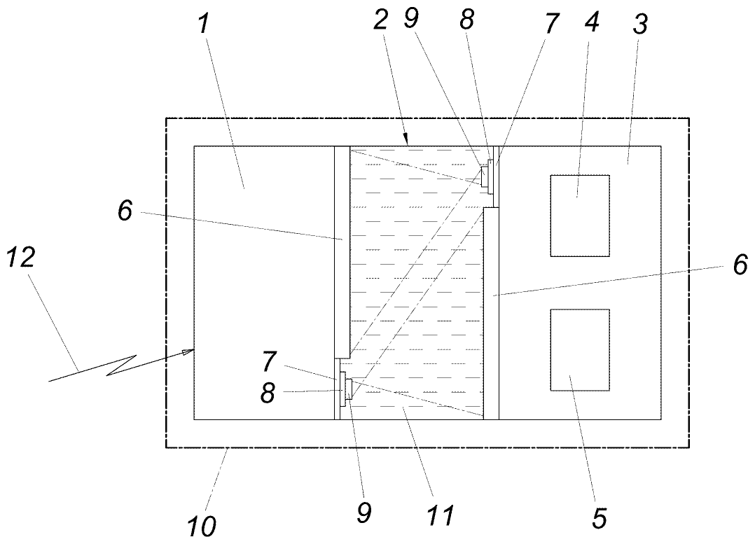

### FIELD OF THE INVENTION

The invention relates to a device for transforming a dataset with a secret key, wherein a query unit is connected via a bidirectional communication interface to a transformation unit comprising a memory for the secret key and a processor for transforming the dataset.

### DESCRIPTION OF THE PRIOR ART

In the processing of digital transactions, the signature of the transaction datasets and the authentication of the user are regularly based on asymmetric encryption procedures. In order to be able to carry out such transactions under the highest possible security conditions, it is essential, particularly in connection with transactions based on cryptocurrencies, that not only the transformation of the corresponding datasets can be carried out in a reliable manner, but also that measures are taken to allow secure storage of the secret keys required for transaction processing as well as the tokenized values of the cryptocurrencies.

Against this background, devices have already been proposed that provide a transformation unit with a memory for the secret key and a processor for transforming the dataset. The transformation unit can, for example, be designed as a so-called mobile cryptowallet that can be connected to a query unit connected to a network or the Internet via a USB interface in order to carry out the transaction. Although such transformation units in principle permit offline storage of secret keys as well as optionally tokenized values, users are nevertheless exposed to a considerable security risk. For example, the bus connection established between the transformation unit and the query unit during transaction processing cannot yet be reasonably protected against side-channel analyses originating from the query unit or invasive attacks to damage the transformation unit, not least because of the transmission software required in the process. Another disadvantage of the devices known from the prior art is that if the transformation unit is lost, the secret keys and tokenized values stored in it are also irrevocably lost.

There is thus a need for a device of the type described at the outset that enables reliable and secure processing of digital transactions, especially those protected against side-channel attacks, while ensuring long-term safekeeping of the sensitive secret keys.

### SUMMARY OF THE INVENTION

The invention solves the posed problem in that the query unit comprises a plurality of optical transmitters for parallel transmission of codewords of the dataset translated into two-dimensional codewords to a plurality of optical receivers of the transformation unit, and the transformation unit comprises a plurality of optical transmitters for parallel transmission of codewords of the transformed dataset translated into two-dimensional codewords to a plurality of optical receivers of the query unit, wherein transmitters and receivers of one unit are each arranged in a two-dimensional grid and opposite and at a distance from the receivers and transmitters of the other unit. As a result of these features, permanent physical separation of the transformation unit and the sensitive secret keys stored thereon from surrounding access systems connected to the query unit is initially achieved. A transformation of a dataset can mean, for example, that the dataset is fully encrypted or that, when a transaction is processed, the dataset is signed in the transformation unit, whereupon the signed dataset can be transmitted via the query unit to the blockchain, for example, and stored therein after a successful integrity check. In this context, a signature can be understood to mean, for example, the addition of an encrypted hash value of itself to the dataset. Since no physical connection between the transformation unit and the query unit is required for transmission, which potentially allows side-channel attacks or even has vulnerabilities, the physical possibilities of optical transmission with the aid of the two-dimensional codewords alone create the security-relevant limitations. The invention is based on the consideration that, due to the parallel transmission of two-dimensional codewords, the information content of the individual codewords is so high compared to the dataset that successful manipulation of the transmission by interfering with the transmission channel is no longer possible. Depending on the coding methods used and the corresponding methods for error correction, the injection of damaging information fails due to the specified integrity or the simultaneous optical transmission of the two-dimensional codewords. This is especially the case if the error correction used in the codewords allows for more than one error, as is the case with Reed-Solomon codes, for example. In principle, each untransformed or transformed dataset transmitted for the transaction from the query unit to the transformation unit, et vice versa, can be translated exactly into a codeword. However, it is also conceivable that the corresponding untransformed or transformed datasets can each be translated into several codewords that are transmitted one after the other. In this case, an attack by manipulation of an external clock can also be excluded by using the image change at the optical transmitters themselves as the transmission clock. Particularly advantageous conditions arise with regard to transmission reliability and transmission duration if the side lengths of the two-dimensional grid at optical transmitters and/or receivers are greater than 10, preferably greater than 20, in the same way as the side lengths of the two-dimensional codewords. This means that more than 10, preferably more than 20 code elements, for example black or white symbol cells, are provided along both directions of extension of the codewords, for the transmission of which at least the same number of optical transmitters and receivers must be provided. With one codeword, more than 50, preferably more than 100, particularly preferably more than 200 bits of the dataset or the transformed dataset can be transmitted.

Although exactly one optical receiver can be assigned to each optical transmitter, the information that can be transmitted in parallel in a codeword can be increased with little effort to save space if the optical transmitters are the pixels of a display and the optical receivers are the pixels of an image sensor. In this way, existing standard components can be used, which favors production of the device according to the invention in large quantities.

In this context, it is proposed that a central projecting optical system be provided between the displays and the image sensors. Due to the fact that image sensors can be manufactured correspondingly small even with high resolution, so that the image sensors are smaller than the displays, the entire bidirectional transmission system comprising the respective transmitters and receivers can essentially be limited to the size of the display, so that in addition to reliable optical transmission, a particularly compact design of the device is made possible.

For example, it can be provided that the two-dimensional codewords can form matrix codes, in particular quick response codes, with the specified code elements being assigned to one or more optical transmitters. In this context, the code elements can be the usually either black or white symbol cells of the code matrix, which symbol cells are square in the case of the quick response code. Due to their extensive transformation invariance, quick response codes have the advantage that exact alignment between the optical transmitters and the optical receivers can be dispensed with. In addition, these codes have a high degree of redundancy, which makes it even more difficult to introduce damaging information.

To prevent physical interference with the optical interface, it is recommended that the transformation unit and the query unit be housed in a common housing. To further increase security, it can also be provided that the housing has a resistance measuring device. If the transformation of the datasets is now carried out on the basis of a predefined resistance value and the resistance measuring device detects a value that deviates from the predefined resistance value, for example by forcibly breaking open the housing, the transactions are interrupted and access to the system is blocked.

For particularly good security conditions, the intermediate space between the optical transmitters and the opposing optical receivers can be provided with an optically permeable potting compound. Optical permeability is understood to mean that distortion-free transmission is possible with respect to the optical signals. For example, suitable polyurethane-based casting resins or polyacrylates can be provided for this purpose. In a particularly favorable embodiment, optically anisotropic casting compounds can be used, for example those having different refractive indices depending on the spatial direction, so that the optical transmission required for distortion-free optical transmission is only provided in the transmission direction, while light incident transversely thereto cannot interfere with the transmission.

The invention also relates to a method for transforming a dataset with a secret key, wherein a dataset is transmitted from a query unit to a transformation unit, transformed using a key stored in the transformation unit, and the transformed dataset is returned to the query unit. In this process, the untransformed dataset is translated into two-dimensional codewords by the query unit, and their code elements are transmitted optically and in parallel to the transformation unit, where they are transformed. The transformed dataset is again translated by the transformation unit into two-dimensional codewords, and their code elements are transmitted optically and in parallel to the query unit.

### BRIEF DESCRIPTION OF THE INVENTION

In the drawing, the subject matter of the invention is shown by way of example, in a schematic top view of a device according to the invention.

### DETAILED DESCRIPTION OF THE PREFERRED EMBODIMENTS

A device according to the invention for transforming a dataset with a secret key has a query unit 1, which is connected to a transformation unit 3 via a bidirectional communication interface 2. The transformation unit 3 comprises a memory 4 for the secret key, for example a private key generated for asymmetric encryption methods, and a processor 5 for transforming the dataset.

Both the query unit 1 and the transformation unit 3 each comprise several optical transmitters, which are, for example, several pixels of a display 6, and several optical receivers, which are, for example, several pixels of an image sensor 8 mounted, for example, on a circuit board 7. In this case, the display 6 and the image sensor 8 of the query unit 1 face the display 6 and the image sensor 8 of the transformation unit 3 at a distance. In addition, a central projecting optical system 9 is arranged on each of the image sensors 8. The beam paths of the image projection formed between the displays 6 and the image sensors 8 or optics 9 are indicated schematically by dashed lines in the drawing shown.

The query unit 1 and the transformation unit 3 may be housed in a common housing 10, and the intermediate space between the displays 6 and the opposing image sensors 7 may be provided with an optically permeable potting compound 11.

To transform a dataset with a secret key, a dataset is transmitted from the query unit 1 to the transformation unit 3 so that the dataset is transformed, i.e. signed, for example, using a key stored in the transformation unit 3, and the transformed dataset can be returned to the query unit 1. The query unit 1 can forward the transformed dataset via a network interface 12, for example to a blockchain.

When the untransformed dataset is transferred from the query unit 1, the dataset is translated by the query unit 1 into two-dimensional codewords and their code elements are transferred optically and in parallel to the transformation unit 3, where they are retranslated and transformed with the aid of the processor 5. The transformed dataset is in turn also translated by the transformation unit 3 into two-dimensional codewords and their code elements are transmitted optically and in parallel to the query unit 1. For example, it may be provided that the two-dimensional codewords form matrix codes, in particular quick response codes, which are imaged on the displays 6 and received by the respective opposing image sensors 8. In this case, the code elements can be the usually either black or white symbol cells of the code matrix, which symbol cells are square in the case of the quick response code.

To improve transmission reliability, each code element, such as each symbol cell, can be assigned several optical transmitters and/or several optical receivers for parallel transmission of the code element via several transmitters and/or receivers, so that transmission reliability is further increased.

1. A device for transforming a dataset with a secret key, said device comprising:
a query unit connected via a bidirectional communication interface to a transformation unit, said transformation unit comprising a memory storing the secret key and a processor transforming the dataset;
wherein the query unit comprises a plurality of optical transmitters providing parallel transmission of codewords of the dataset translated into two-dimensional codewords to a plurality of optical receivers of the transformation unit; and
wherein the transformation unit comprises a plurality of optical transmitters providing parallel transmission of codewords of the transformed dataset translated into two-dimensional codewords to a plurality of optical receivers of the query unit; and
wherein the transmitters and receivers of one of the units are each arranged in a respective two-dimensional grid and opposite and at a distance from the receivers and transmitters of the other of the units.

2. The device according to claim 1, wherein the optical transmitters are pixels of a display, and the optical receivers are pixels of an image sensor.

3. The device according to claim 2, wherein a central projecting optical system is provided between the displays and the image sensors.

4. The device according to claim 1, wherein the two-dimensional codewords form quick response codes.

5. The device according to claim 1, wherein the transformation unit and the query unit are supported in a common housing.

6. The device according to claim 1, wherein the optical transmitters and the opposing optical receivers define a space therebetween and an optically permeable potting compound is provided in said space.

7. A method for transforming a dataset with a secret key, said method comprising:
transmitting the dataset from a query unit to a transformation unit; and
transforming the dataset based on a key stored in the transformation unit; and
returning the transformed dataset to the query unit;
wherein the dataset is translated by the query unit into two-dimensional codewords having code elements that are transmitted optically and in parallel to the transformation unit; and
wherein the transformed dataset is translated by the transformation unit into two-dimensional codewords having code elements that are transmitted optically and in parallel to the query unit.

8. The device according to claim 2, wherein the two-dimensional codewords form quick response codes.

9. The device according to claim 3, wherein the two-dimensional codewords form quick response codes.

10. The device according to claim 2, wherein the transformation unit and the query unit are supported in a common housing.

11. The device according to claim 3, wherein the transformation unit and the query unit are supported in a common housing.

12. The device according to claim 4, wherein the transformation unit and the query unit are supported in a common housing.

13. The device according to claim 2, wherein the optical transmitters and the opposing optical receivers define a space therebetween and an optically permeable potting compound is provided in said space.

14. The device according to claim 3, wherein the optical transmitters and the opposing optical receivers define a space therebetween and an optically permeable potting compound is provided in said space.

15. The device according to claim 4, wherein the optical transmitters and the opposing optical receivers define a space therebetween and an optically permeable potting compound is provided in said space.

16. The device according to claim 5, wherein the optical transmitters and the opposing optical receivers define a space therebetween and an optically permeable potting compound is provided in said space.
